(19) United States
(12) Patent Application Publication
(10) Pub. No.: US 2014/0320933 A1
(43) Pub. Date: Oct. 30, 2014

(54) IMAGE PROCESSING APPARATUS AND IMAGE FORMING APPARATUS

(71) Applicant: KYOCERA Document Solutions Inc., Osaka (JP)

(72) Inventor: Masato Shiose, Osaka (JP)

(73) Assignee: KYOCERA Document Solutions Inc., Osaka (JP)

(21) Appl. No.: 14/257,883

(22) Filed: Apr. 21, 2014

(30) Foreign Application Priority Data
Apr. 24, 2013 (JP) 2013-091371

(51) Int. Cl. H04N 1/393; H04N 1/00; G06T 11/60

(52) U.S. Cl. CPC H04N 1/393; G06T 11/60; H04N 1/00469; H04N 2201/21; H04N 2201/3243; H04N 2201/3242
USPC 358/452

(57) ABSTRACT

An area defining portion defines an edit area based on an area specifying image included in a read image read from a document by an image reading portion or on an area specifying image inputted through a drawing operation on a document image displayed on a display input portion. The area defining portion defines one or more edit areas. A determination portion determines whether or not an element image is present on a profile line of the edit area in the document image retrieved by a retrieval control portion. An area enlarging portion enlarges the edit area determined by the determination portion as having the element image on the profile line to a range in which the element image is no longer present on the profile line.

### INCORPORATION BY REFERENCE

This application is based upon and claims the benefit of priority from the corresponding Japanese Patent Application No. 2013-091371 filed on Apr. 24, 2013, the entire contents of which are incorporated herein by reference.

### BACKGROUND

The present disclosure relates to an image processing apparatus and an image forming apparatus that can perform image processing on an edit area arbitrarily specified in a document image.

Image processing apparatuses such as scanners, copying machines, and multifunction peripherals generally have an image processing function to perform image processing such as magnification of an image read from a document. In particular, a technique is known by which an edit area is defined based on a handwritten image included in an image read from a document, and an image in the edit area is magnified.

### SUMMARY

An image processing apparatus according to an aspect of the present disclosure includes a retrieval control portion, an area defining portion, a determination portion, an area enlarging portion, and an image processing portion. The retrieval control portion retrieves a document image stored in a storage portion. The area defining portion defines an edit area based on an area specifying image included in a read image read from a document by an image reading portion or on an area specifying image inputted through a drawing operation on the document image displayed on a display input portion. The area defining portion defines one or more edit areas. The determination portion determines whether or not an element image is present on a profile line of the edit area in the document image retrieved by the retrieval control portion. The area enlarging portion enlarges the edit area determined by the determination portion as having the element image on the profile line to a range in which the element image is no longer present on the profile line. The image processing portion performs predetermined image processing on an image in the edit area enlarged by the area enlarging portion out of the document image.

An image forming apparatus according to another aspect of the present disclosure includes a retrieval control portion, an area defining portion, a determination portion, an area enlarging portion, an image processing portion, and an image forming portion. The image forming portion forms an image on a sheet based on an image after image processing by the image processing portion.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1A and 1B are schematic configuration diagrams of a multifunction peripheral according to an embodiment of the present disclosure.

FIG. 2 is a flowchart showing an example of a set of procedures of image editing processing to be performed in the multifunction peripheral according to the embodiment of the present disclosure.

FIGS. 3A and 3B are diagrams illustrating details of the image editing processing to be performed in the multifunction peripheral according to the embodiment of the present disclosure.

FIGS. 4A and 4B are diagrams illustrating details of the image editing processing to be performed in the multifunction peripheral according to the embodiment of the present disclosure.

FIG. 5 is a diagram showing a result of the image editing processing performed in the multifunction peripheral according to the embodiment of the present disclosure.

FIGS. 6A and 6B are diagrams showing a result of the image editing processing performed in the multifunction peripheral according to the embodiment of the present disclosure.

FIG. 7 is a flowchart showing another example of a set of procedures of the image editing processing to be performed in the multifunction peripheral according to the embodiment of the present disclosure.

### DETAILED DESCRIPTION

[Schematic Configuration of Multifunction Peripheral 10]

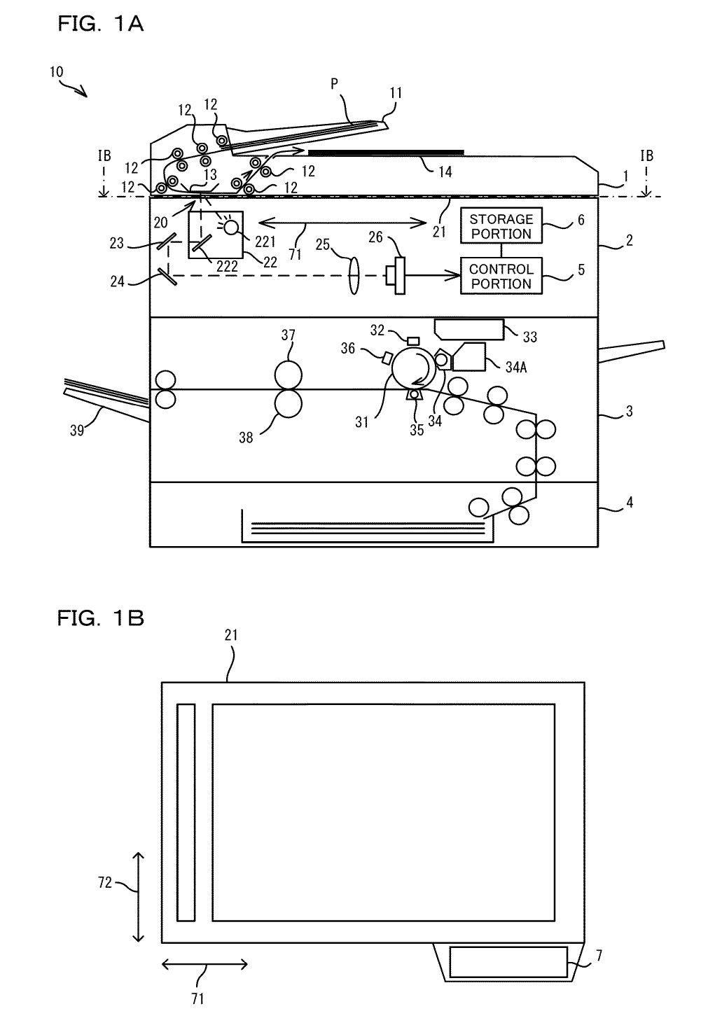

First, a schematic configuration of the multifunction peripheral 10 according to an embodiment of the present disclosure will be described with reference to FIGS. 1A and 1B. FIG. 1A is a diagram showing the configuration of the multifunction peripheral 10. FIG. 1B is a view as seen from the direction of arrows IB-IB in FIG. 1A. The multifunction peripheral 10 is an example of an image processing apparatus and an image forming apparatus according to the present disclosure. The present disclosure can be applied to image processing apparatuses or image forming apparatuses such as printers, facsimile machines, copying machines, multifunction peripherals, personal computers, tablets, smartphones, and mobile phones.

As shown in FIGS. 1A and 1B, the multifunction peripheral 10 is an image forming apparatus including an ADF 1, an image reading portion 2, an image forming portion 3, a sheet feed cassette 4, a control portion 5, a storage portion 6, an operation display portion 7, and so on. The operation display portion 7 is a display input portion such as a touch panel which displays various pieces of information according to control instructions from the control portion 5 and through which various pieces of information are inputted into the control portion 5 according to an operation by a user.

As shown in FIG. 1A, the ADF 1 is an automatic document feeder including a document setting portion 11, a plurality of conveyance rollers 12, a document holding portion 13, a sheet discharge portion 14, and so on. In the ADF 1, the respective conveyance rollers 12 are driven by a motor, not shown, and thereby a document P on the document setting portion 11 is conveyed to the sheet discharge portion 14 through a reading position 20 where image data is read by the image reading portion 2. Thus, the image reading portion 2 can read the image data from the document P being conveyed by the ADF 1.

The image reading portion 2 includes a document table 21, a light source unit 22, mirrors 23 and 24, an optical lens 25, a CCD (Charge Coupled Device) 26, and so on. The document table 21 is a portion which is provided on an upper surface of the image reading portion 2 and on which the document P is placed. The light source unit 22 includes an LED light source 221 and a mirror 222, and can be moved in a secondary scanning direction 71 by a motor, not shown. The LED light source 221 includes a plurality of white LEDs arranged along a primary scanning direction 72. The mirror 222 reflects, toward the mirror 23, light emitted by the LED light source 221 and reflected from a surface of the document P in the reading position 20 on the document table 21. The light reflected from the mirror 222 is then guided to the optical lens 25 by the mirrors 23 and 24. The optical lens 25 converges the light incident thereon and causes the converged light to enter the CCD 26. The CCD 26 has a photoelectric conversion element or the like that inputs in the control portion 5 electrical signals according to the amount of the light that has entered from the optical lens 25 as image data of the document P.

The image forming portion 3 is an electrophotographic image forming portion that performs image forming processing (printing processing) based on the image data read by the image reading portion 2 or image data inputted from an external information processing apparatus such as a personal computer. Specifically, as shown in FIG. 1A, the image forming portion 3 includes a photosensitive drum 31, a charging device 32, an exposure device (LSU) 33, a developing device 34, a transfer roller 35, a destaticizing device 36, a fixing roller 37, a pressurizing roller 38, a sheet discharge tray 39, and so on. In the image forming portion 3, an image is formed on a paper sheet fed from the sheet feed cassette 4 by the procedures described below, and the paper sheet on which the image has been formed is discharged onto the sheet discharge tray 39.

First, the photosensitive drum 31 is uniformly charged at a predetermined potential by the charging device 32. Next, light based on the image data is applied to a surface of the photosensitive drum 31 by the exposure device 33. Thereby, an electrostatic latent image corresponding to the image data is formed on the surface of the photosensitive drum 31. The electrostatic latent image on the photosensitive drum 31 is then developed (made visible) as a toner image by the developing device 34. A toner (developer) is supplied to the developing device 34 from a toner container 34A that is attachable to and detachable from the image forming portion 3. Subsequently, the toner image formed on the photosensitive drum 31 is transferred to a paper sheet by the transfer roller 35. Thereafter, the toner image transferred on the paper sheet is heated, melted, and fixed by the fixing roller 37 while the paper sheet is passing between the fixing roller 37 and the pressurizing roller 38. The potential on the photosensitive drum 31 is removed by the destaticizing device 36.

The control portion 5 has control instruments such as a CPU, a ROM, a RAM, and an EEPROM. The CPU is a processor that performs various types of arithmetic processing. The ROM is a nonvolatile storage portion in which information such as control programs to cause the CPU to perform various types of processing is prestored. The RAM is a volatile storage portion, and the EEPROM is a nonvolatile storage portion. The RAM and the EEPROM are used as temporary storage memories (work spaces) for various types of processing to be performed by the CPU.

The control portion 5 performs overall control of the multifunction peripheral 10 by executing the various control programs prestored in the ROM by means of the CPU. The control portion 5 may be formed of an electronic circuit such as integrated circuits (ASIC and DSP). The control portion 5 may be a control portion provided separately from a main control portion that provides overall control of the multifunction peripheral 10.

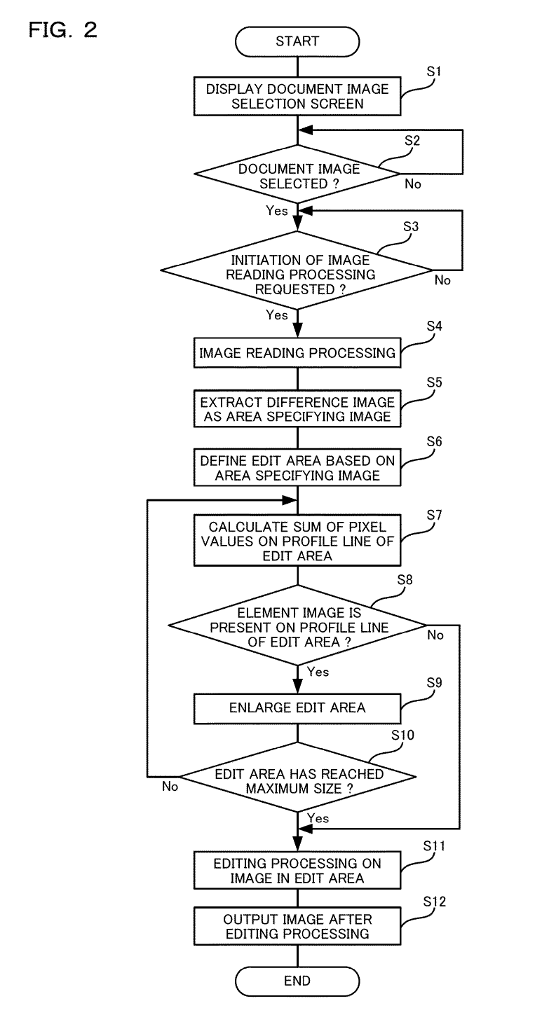

Furthermore, in the ROM or the EEPROM of the control portion 5, an image editing program to cause the CPU of the control portion 5 to perform image editing processing described later (see a flowchart in FIG. 2) is prestored. The image editing program is stored in a computer-readable recording medium such as a CD, a DVD, and a flash memory, and read from the recording medium and installed in a storage portion such as the EEPROM of the control portion 5 or a hard disk, not shown. The present disclosure may also be understood as disclosure of a method of performing procedures of the image editing processing in the multifunction peripheral 10, of an image editing program to cause the control portion 5 to perform procedures of the image editing processing, or of a computer-readable recording medium in which the image editing program is stored.

The storage portion 6 is a nonvolatile storage portion such as a hard disk or an SSD in which image data read by the image reading portion 2 or image data inputted from an external information processing apparatus such as a personal computer is stored. The storage portion 6 may be provided outside the multifunction peripheral 10 as long as the control portion 5 can retrieve the image data from the storage portion 6.

[Image Editing Processing]

Hereinafter, an example of a set of procedures of the image editing processing to be performed by the control portion 5 will be described with reference to FIG. 2. It should be noted that steps S1, S2, and so on represent numbers of the procedures (steps) to be performed by the control portion 5. The image editing processing is performed by the control portion 5 when initiation of the image editing processing is requested through an operation on the operation display portion 7 by a user in the multifunction peripheral 10.

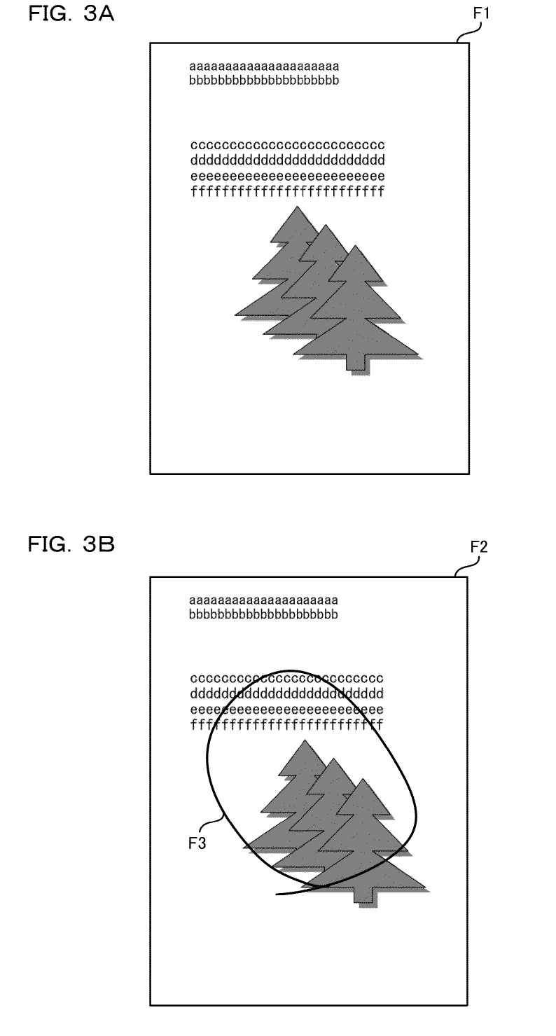

The present embodiment is on the assumption that image data of a document image F1 shown in FIG. 3A is prestored in the storage portion 6. Hereinafter, the image editing processing will be described in the context of the case where a read image F2 shown in FIG. 3B is read by the image reading portion 2 from a document which is a printed matter of the document image F1 and on which an area specifying image has been handwritten by a user. The area specifying image is a line image that is drawn on the printed matter of the document image F1 by a user in order to arbitrarily select an area to be subjected to image processing. The document image F1 may be read by the image reading portion 2 during the image editing processing and stored in the storage portion 6.

<Step S1>

First, in step S1, the control portion 5 causes the operation display portion 7 to display a selection screen on which a document image to be subjected to the present editing is selected out of one or more document images stored in the storage portion 6.

<Step S2>

In step S2, the control portion 5 waits for the selection of the document image on the selection screen displayed in step S1 (No in S2). The control portion 5 shifts the processing to step S3 once the document image has been selected (Yes in S2). Here, the document image F1 (see FIG. 3A) is selected by a user on the selection screen. The procedures (S1 and S2) for the user to select the document image F1 may be performed after image reading processing in step S4 described later is performed.

<Step S3>

Next, in step S3, the control portion 5 waits for an operation requesting initiation of the image reading processing on the operation display portion 7 (No in S3). The control portion 5 shifts the processing to step S4 once the operation requesting initiation of the image reading processing has been performed (Yes in S3).

<Step S4>

In step S4, the control portion 5 performs the image reading processing in which the image reading portion 2 reads an image from a document set on the ADF 1 or on the document table 21. Hereinafter, the image read in step S4 is referred to as read image. Here, the image reading portion 2 reads the read image F2 shown in FIG. 3B from the document which is the printed matter of the document image F1 and on which the area specifying image has been written.

<Step S5>

In step S5, the control portion 5 retrieves the document image from the storage portion 6, compares the read image with the document image, and extracts one or more difference images as one or more area specifying images. The control portion 5 retrieving the document image is an example of a retrieval control portion. Here, the area specifying image F3 shown in FIG. 3B is extracted as a difference image of the document image F1 shown in FIG. 3A and the read image F2 shown in FIG. 3B.

<Step S6>

In step S6, the control portion 5 defines one or more edit areas based on the one or more area specifying images extracted in step S5. Here, the control portion 5 performing such processing is an example of an area defining portion.

Specifically, the control portion 5 defines, as each of the one or more edit areas, a rectangular area framed by opposite end positions of each of the one or more area specifying images in a horizontal direction (left-right direction in FIG. 3B) and opposite end positions of the area specifying image in a vertical direction (up-down direction in FIG. 3B). That is, the control portion 5 defines the area of a rectangle circumscribing the area specifying image as the edit area.

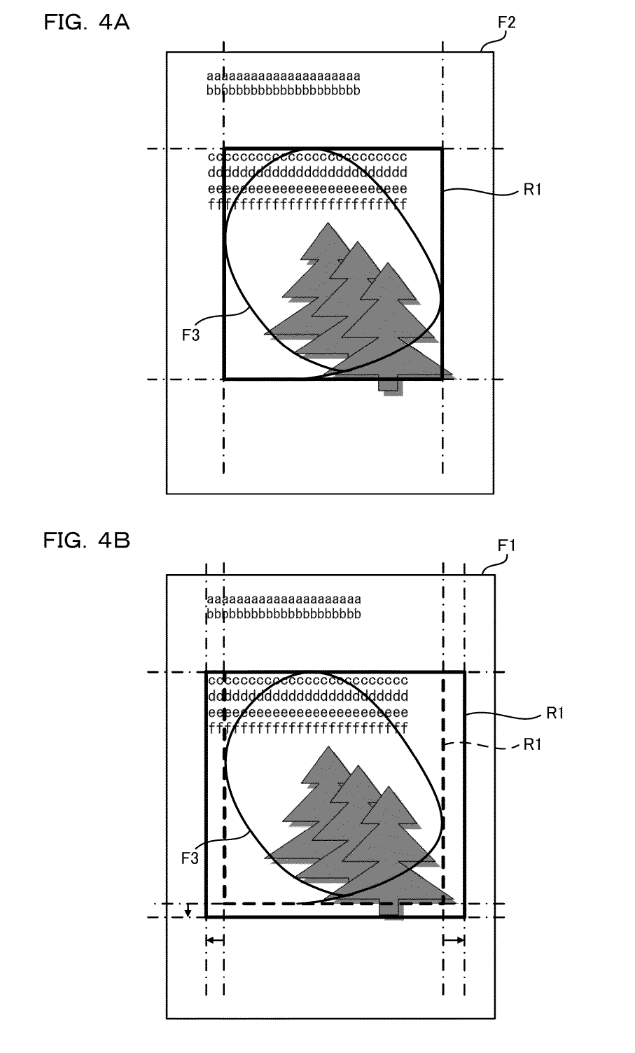

Here, as shown in FIG. 4A, a rectangular area framed by opposite end positions of the area specifying image F3 in the horizontal direction and opposite end positions of the area specifying image F3 in the vertical direction in the read image F2, that is, an area of a rectangle circumscribing the area specifying image F3 is defined as an edit area R1.

The shape of the edit area is not limited to a rectangle. For example, when the area specifying image has a shape similar to a polygon such as a triangle or a circle (including an oval), the control portion 5 may define an area of a polygon such as a triangle or a circle that circumscribes the area specifying image as the edit area. Alternatively, the area specifying image may be defined as the edit area as is. When the area specifying image has a circular shape, for example, enlargement of the edit area described later is performed concentrically, for example.

<Step S7>

Subsequently, in step S7, the control portion 5 calculates the sum of pixel values on the profile line of the edit area in the document image based on the document image and position coordinates of the edit area. When there are a plurality of edit areas, the processing in step S7 is performed for each of the edit areas.

Specifically, the control portion 5 calculates the sum of pixel values for each side forming the profile line of the edit area. The pixel values represent the density of each pixel in the document image. For example, a pixel value “0” represents “white” and a pixel value “255” represents “black”. In another embodiment, the control portion 5 may calculate the average of pixel values for each side forming the profile line of the edit area in the document image. Alternatively, the control portion 5 may calculate the sum or the average of pixel values on the entire profile line of the edit area.

Incidentally, when an element image such as a drawing or a letter (letters) is present on the profile line of the handwritten image included in the read image, the edit area defined based on the handwritten image will include the element image such as a drawing or a letter (letters) broken by the profile line. Against the problem, the procedure described below is performed in the multifunction peripheral 10 according to the present embodiment to define, as the edit area, an area in which the element image such as a drawing or a letter (letters) is not broken.

<Step S8>

Next, in step S8, the control portion 5 determines whether or not an element image such as a drawing or a letter (letters) is present on the profile line of the edit area in the document image. Here, the control portion 5 performing such processing is an example of a determination portion. Specifically, the control portion 5 determines for each side of the profile line of the edit area whether or not the sum of pixel values calculated in step S7 is not less than a predetermined threshold. The threshold is a value preliminarily determined as an index for determining whether or not an element image such as a drawing or a letter (letters) is present on the profile line of the edit area.

Thus, the control portion 5 can determine whether or not an element image such as a drawing or a letter (letters) is present on the profile line of the edit area according to a result of a comparison of the sum of the pixel values with the threshold. When there are a plurality of edit areas, the processing in step S8 is performed for each of the edit areas. When a pixel value “0” represents “black” and a pixel value “255” represents “white”, it is determined in step S8 whether or not the sum of the pixel values is not greater than a threshold preliminarily determined as an index for determining whether or not the element image is present on the profile line of the edit area.

The control portion 5 shifts the processing to step S9 once it determines that the sum of the pixel values of at least one side of the profile line of the edit area is not less than the threshold and therefore the element image is present on the profile line of the edit area (Yes in S8). Here, as shown by a dotted line in FIG. 4B, the control portion 5 has determined that drawings and letters are present on the profile line of the edit area R1 in the read image F1 and will therefore shift the processing to step S9. On the other hand, the control portion 5 shifts the processing to step S11 once it determines that the sum of the pixel values is less than the threshold for all the sides of the profile line of the edit area and no element image is present on the profile line of the edit area (No in S8).

<Step S9>

In step S9, the control portion 5 enlarges each of the one or more edit areas determined in step S8 as having the element image on its profile line. Specifically, the control portion 5 shifts the side of the profile line of the edit area determined in step S8 as having a sum of pixel values not less than the threshold by predetermined pixels in a direction for the edit area to be enlarged. The method for the enlargement of the edit area is not limited thereto. In another embodiment, the edit area as a whole may be enlarged with the aspect ratio (ratio of length and breadth) of its own maintained.

<Step S10>

Subsequently, in step S10, the control portion 5 determines whether or not the size of the edit area enlarged in step S9 has reached a predetermined maximum size. Specifically, the control portion 5 determines that the size of the edit area has reached the maximum size when a vertical dimension of the edit area has reached a vertical dimension of the document image or a length shorter than the vertical dimension of the document image by a predetermined amount. The control portion 5 also determines that the size of the edit area has reached the maximum size when a horizontal dimension of the edit area has reached a horizontal dimension of the document image or a length shorter than the horizontal dimension of the document image by a predetermined amount. It should be noted that the maximum size is not limited thereto, and the control portion 5 may determine that the size of the edit area has reached the maximum size when the edit area has been enlarged from an initial size of the edit area at a predetermined magnification or a higher magnification. Thus, the edit area is prevented from being enlarged more than necessary.

The control portion 5 shifts the processing to step S11 once it determines that the size of the edit area has reached the maximum size (Yes in S10). On the other hand, the control portion 5 shifts the processing to step S7 once it determines that the size of the edit area has not reached the maximum size (No in S10). Thus, in steps S7 to S10, the control portion 5 enlarges each of the one or more edit areas determined in step S8 as having the element image on its profile line to a range in which the element image is no longer present on the profile line. However, the enlargement of the edit area is performed within a range of the predetermined maximum size. Here, the control portion 5 performing such processing is an example of an area enlarging portion.

<Step S11>

The processing is shifted to step S11 when it is determined that the element image is not present on the profile line of the edit area or when it is determined that the edit area has reached the maximum size. Subsequently, in step S11, the control portion 5 performs predetermined image processing on an image in the edit area enlarged in steps S7 to S10 out of the document image. Here, the control portion 5 performing such processing is an example of an image processing portion. Specifically, the control portion 5 extracts the image in the edit area out of the document image and performs magnifying processing to magnify the image at a predetermined magnification. When it is determined that the edit area has reached the maximum size, the control portion 5 performs, in step S11, the magnifying processing on the image in the edit area after the final enlargement or on the image in the initial edit area, for example.

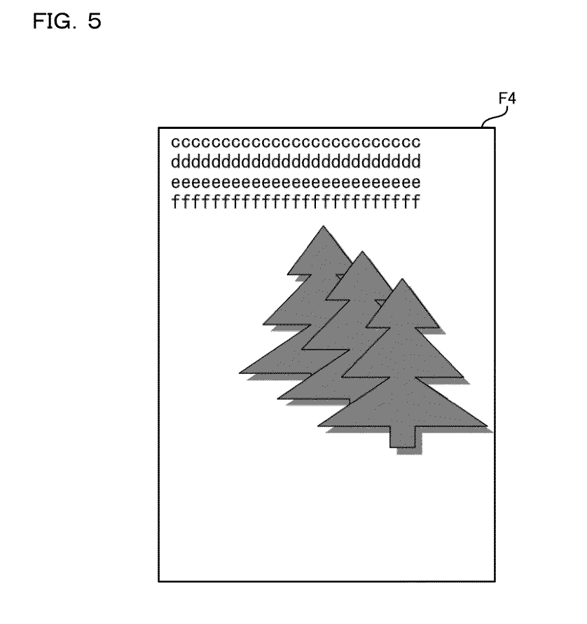

FIG. 5 is a diagram showing an example of an output image F4 to be outputted after the magnifying processing. As shown in FIG. 5, the image in the edit area R1 is magnified unbroken in the output image F4. Here, the magnification is a ratio at which at least one of the horizontal dimension and the vertical dimension of the edit area R1 is magnified up to the dimension of the document image F1 in the same direction when the edit area R1 is magnified with the current aspect ratio of the edit area R1 maintained, for example. That is, the edit area R1 is magnified to a maximum size within the same sheet size as the document image F1 with its current aspect ratio maintained. It is needless to say that the magnification may be a predetermined constant value or a value set by the control portion 5 according to an operation on the operation display portion 7 by a user.

<Step S12>

Subsequently, in step S12, the control portion 5 outputs the image in the edit area after the image processing in step S11. Specifically, the control portion 5 can output data of the image in the edit area to the image forming portion 3 and print the image on a sheet. In addition, the control portion 5 is capable of storing the image in the edit area after the image processing in step S11 in the storage portion 6 as data of an image different from the document image and the read image or transmitting the image to an information processing apparatus such as a personal computer.

As described above, when an element image such as a drawing or a letter (letters) is present on the profile line of the edit area defined based on the area specifying image in the multifunction peripheral 10, the edit area is enlarged to a size in which the profile line of the edit area no longer overlaps with the element image. Accordingly, the multifunction peripheral 10 can provide an output image in which an element image such as a drawing or a letter (letters) is not broken.

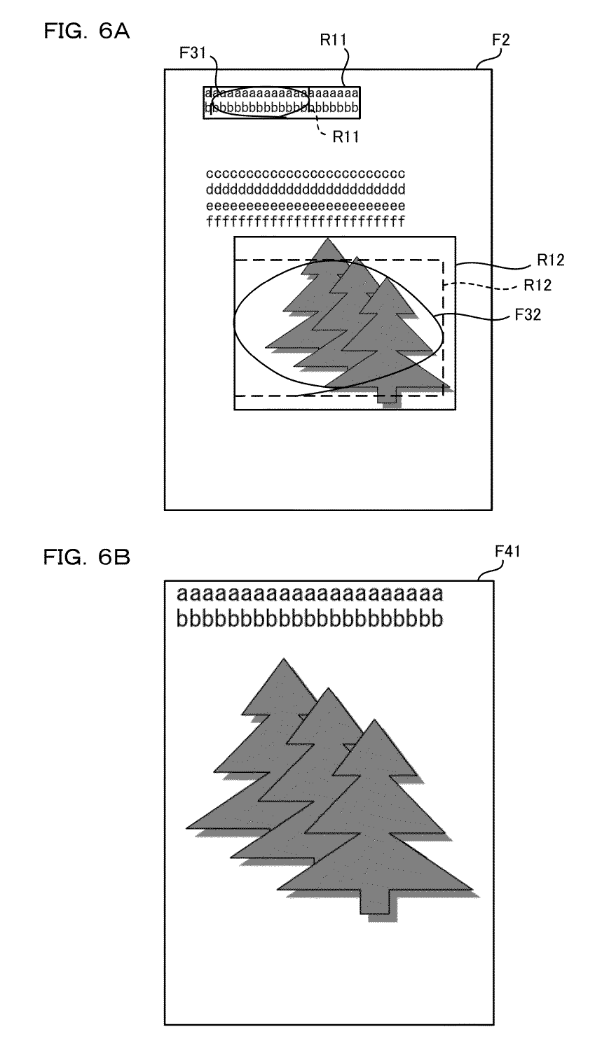

FIGS. 6A and 6B show the case where the read image F2 includes a plurality of area specifying images F31 and F32, and a result of the image editing processing performed in this case. In the image editing processing, in this case, the plurality of area specifying images F31 and F32 are extracted as shown in FIG. 6A based on the comparison of the read image F2 with the document image F1 shown in FIG. 3A, in step S5. In step S6, edit areas R11 and R12 are defined based on the area specifying images F31 and F32, respectively. However, a letter (letters) or a drawing is present on the profile lines of the areas of the rectangles circumscribing the area specifying images F31 and F32. In following steps S7 to S10, therefore, each of the edit areas R11 and R12 will be enlarged to a range in which the profile line no longer overlaps with the letter (letters) or the drawing as shown in FIG. 6A. In steps S11 and S12, each of the images in the edit areas R11 and R12 is magnified to a maximum size within the same sheet size as the document image F1 and outputted as shown in FIG. 6B. In another embodiment, the image in the edit area R11 and the image in the edit area R12 may be outputted on different pages. In the read image F2, incidentally, there is a gap between the edit area R12 and the element image at a part of the profile line (left-hand side) of the area specifying image F32. Accordingly, the control portion 5 may reduce the edit area R12 so as to decrease the gap between the edit area R12 and the element image in stages, and fix the edit area R12 at a size one stage before a size in which the edit area R12 overlaps with the element image.

The image processing to be performed in step S11 is not limited to the magnifying processing. Other examples of the image processing may include cropping processing to crop the image in the edit area and output the image as cropped, minifying processing to minify the image in the edit area and output the image, and color changing processing to change the color of the image in the edit area.

In the embodiments given above, the case has been described as an example where the control portion 5 selects the document image stored in the storage portion 6 according to an operation on the operation display portion 7 by a user. In another embodiment, the control portion 5 may automatically select the document image corresponding to the read image read by the image reading portion 2 out of the image data stored in the storage portion 6 based on the read image. For example, a document to be read by the image reading portion 2 may include identification information such as a digital watermark or a bar code showing the correspondence with the document image, and the control portion 5 may specify the document image based on the identification information. In this case, furthermore, the control portion 5 may have a function of adding the identification information to the image data stored in the storage portion 6 and printing the same. In the case where the identification information is included in the document, the control portion 5 compares the read image with the document image after eliminating the identification information from the read image.

### Other Embodiments

In the embodiments given above, the configuration has been described in which a difference image of the document image stored in the storage portion 6 and the read image read by the image reading portion 2 is extracted as the area specifying image, and the edit area is defined based on the area specifying image. Hereinafter, another configuration will be described in which the control portion 5 in the multifunction peripheral 10 defines the edit area based on an area specifying image given through a drawing operation on the operation display portion 7 by a user.

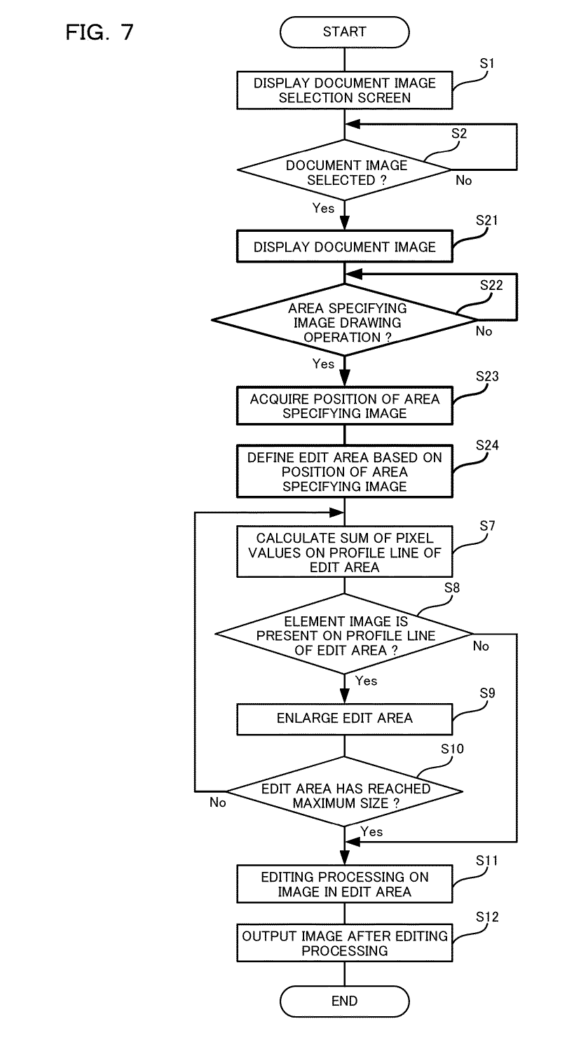

Hereinafter, another example of the set of procedures of the image editing processing to be performed by the control portion 5 will be described with reference to FIG. 7. The same procedures as those of the image editing processing shown in FIG. 2 will be given the same step numbers, and description thereof will be omitted. Specifically, in the image editing processing shown in FIG. 7, the control portion 5 performs procedures of steps S21 to S24 instead of those of steps S3 to S6.

<Step S21>

First, once the document image has been selected in step S2 (Yes in S2), the control portion 5 causes the operation display portion 7 to display the document image in following step S21. Thereby, a user is allowed to input an area specifying image through a drawing operation with a finger or a stylus on the document image displayed on the operation display portion 7. Once the area specifying image has been inputted through the drawing operation, the control portion 5 causes the operation display portion 7 to display the area specifying image.

<Step S22>

In step S22, the control portion 5 waits for the operation of drawing the area specifying image on the operation display portion 7 (No in S22). For example, the control portion 5 determines that the drawing operation has been performed when the operation of drawing the area specifying image is performed on the operation display portion 7 or when an operation of confirming the drawing operation is entered after the drawing operation. The control portion 5 shifts the processing to step S23 once it determines that the operation of drawing the area specifying image has been performed on the operation display portion 7 (Yes in S22).

<Step S23>

In step S23, the control portion 5 acquires, from the operation display portion 7, position coordinates of the area specifying image which has been inputted through the drawing operation on the document image displayed on the operation display portion 7 and which has been displayed on the operation display portion 7.

<Step S24>

In step S24, the control portion 5 defines one or more edit areas based on one or more area specifying images acquired in step S23. Here, the control portion 5 performing such processing is an example of an area defining portion. Specifically, the control portion 5 defines, as each of the one or more edit areas, an area framed by opposite ends in the horizontal direction (left-right direction) and opposite ends in the vertical direction (up-down direction) of each of the one or more area specifying images in the document image displayed on the operation display portion 7. That is, the control portion 5 defines an area of a rectangle circumscribing each of the one or more area specifying images as each of the one or more edit areas.

In step S7 and the following steps, the control portion 5 enlarges each of the one or more edit areas defined in step 24 to a position where the element image is no longer present on the profile line of each of the one or more edit areas, and magnifies and outputs an image in each of the one or more edit areas (S7 to S12). Such a configuration allows the multifunction peripheral 10 to perform image processing on the one or more edit areas by inputting the one or more area specifying images through the drawing operation on the operation display portion 7 without printing and outputting the document image.

It is to be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An image processing apparatus comprising:
a retrieval control portion configured to retrieve a document image stored in a storage portion;
an area defining portion configured to define an edit area based on an area specifying image included in a read image read from a document by an image reading portion or on an area specifying image inputted through a drawing operation on the document image displayed on a display input portion, the area defining portion being configured to define one or more edit areas;
a determination portion configured to determine whether or not an element image is present on a profile line of the edit area in the document image retrieved by the retrieval control portion;
an area enlarging portion configured to enlarge the edit area determined by the determination portion as having the element image on the profile line to a range in which the element image is no longer present on the profile line; and
an image processing portion configured to perform predetermined image processing on an image in the edit area enlarged by the area enlarging portion out of the document image.

2. The image processing apparatus according to claim 1, wherein the area defining portion extracts a difference image of the document image and the read image as the area specifying image.

3. The image processing apparatus according to claim 1, wherein the area defining portion defines an area of a polygon or a circle that circumscribes the area specifying image as the edit area.

4. The image processing apparatus according to claim 1, wherein the determination portion determines whether or not the element image is present on the profile line according to a result of a comparison of pixel values on the profile line in the document image with a predetermined threshold.

5. The image processing apparatus according to claim 1, wherein the area enlarging portion enlarges the edit area within a range of a predetermined maximum size.

6. The image processing apparatus according to claim 1, wherein the image processing is magnifying processing to magnify the image in the edit area at a predetermined magnification and output the magnified image.

7. An image forming apparatus comprising:
a retrieval control portion configured to retrieve a document image stored in a storage portion;
an area defining portion configured to define an edit area based on an area specifying image included in a read image read from a document by an image reading portion or on an area specifying image inputted through a drawing operation on the document image displayed on a display input portion, the area defining portion being configured to define one or more edit areas;
a determination portion configured to determine whether or not an element image is present on a profile line of the edit area in the document image retrieved by the retrieval control portion;
an area enlarging portion configured to enlarge the edit area determined by the determination portion as having the element image on the profile line to a range in which the element image is no longer present on the profile line;
an image processing portion configured to perform predetermined image processing on an image in the edit area enlarged by the area enlarging portion out of the document image; and
an image forming portion configured to print the image after the image processing by the image processing portion.

8. The image forming apparatus according to claim 7, wherein the area defining portion extracts a difference image of the document image and the read image as the area specifying image.

9. The image forming apparatus according to claim 7, wherein the area defining portion defines an area of a polygon or a circle that circumscribes the area specifying image as the edit area.

10. The image forming apparatus according to claim 7, wherein the determination portion determines whether or not the element image is present on the profile line according to a result of a comparison of pixel values on the profile line in the document image with a predetermined threshold.

11. The image forming apparatus according to claim 7, wherein the area enlarging portion enlarges the edit area within a range of a predetermined maximum size.

12. The image forming apparatus according to claim 7, wherein the image processing is magnifying processing to magnify the image in the edit area at a predetermined magnification and output the magnified image.
